(19) United States
(12) Patent Application Publication
(10) Pub. No.: US 2006/0114770 A1
(43) Pub. Date: Jun. 1, 2006

(54) Disk drive with optical pickup unit

(76) Inventor: Tatsuhiro Asabata, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/288,254

(22) Filed: Nov. 29, 2005

(30) Foreign Application Priority Data
Nov. 29, 2004 (JP) 2004-343728

(51) Int. Cl. G11B 7/00

(52) U.S. Cl. 369/44.14

(57) ABSTRACT

In order to prevent dust and dirt from entering the inside of an optical pickup unit of a disk drive without use of a special dustproof cover member, the optical pickup unit has a frame slidably supported by guide shafts, which an internal space is formed in the frame to accommodate an objective lens, an actuator for moving positions of the objective lens in a focus direction and a tracking direction, and other components. A circuit board functioning as a relay for a control circuit board is mounted to the upper end of the frame masking the internal space, and an aperture is formed at a position corresponding to the objective lens.

### BACKGROUND OF THE INVENTION

1. Field of the Invention

The present invention relates to a disk drive provided with an optical pickup unit to read information recorded on a disk, or to record information on the disk.

2. Related Art

In a disk drive, an optical pickup reads recorded information out of a rotating disk mounted on a turntable, or records information on the disk. As shown in FIG. 3, an optical pickup unit 3 in a conventional and typical disk drive is configured in which it is movably mounted on two guide shafts 4a and 4b arranged on a traverse chassis 2 of a traverse unit 1, and it moves along the guide shafts 4a and 4b as a rack 7 is moved by rotating a motor 5 coupled to a pinion gear 6.

As shown in FIGS. 4 and 5, the optical pickup unit 3 is configured in which the light of a laser diode being a light-emitting device 8 strikes the recording surface of a disk and the reflected light is detected to convert information recorded on the disk to electrical signals. The light emitted from the light-emitting device 8 is reflected on a half-silvered mirror 9 placed in the optical pickup unit 3, and passes through an objective lens 10 to strike the recording surface of the disk. The light having struck the recording surface of the disk is reflected to again pass through the objective lens 10, penetrates through the half-silvered mirror 9, enters a light-receiving device 11, and the light is converted to electrical signals.

The unit has an actuator 12 so that the objective lens 10 can be moderately moved in the focus direction (vertical direction) and the tracking direction (the radial direction of the disk) and the light emitted from the light-emitting device 8 can accurately trace the recording surface of the disk.

Then, the optical pickup unit 3 is mounted with a relay circuit board 13 to convert information read out of the recording surface of the disk by the light-emitting device 8 to electrical signals and send the converted electrical signals to a control circuit board of the disk drive through a cable. Furthermore, the circuit board 13 also serves as a relay for voltage supply required for drive of the actuator 12 and light emission of the light-emitting device 8.

As described above, the optical pickup unit 3 is an important core in the disk drive. Therefore, it is mounted with a dustproof cover member 14 formed with an aperture 14a through which light is irradiated onto the disk for preventing dust and dirt from entering the actuator 12 moving and adjusting the objective lens 10. However, the dustproof cover member 14 is a component made of resin, which is shaped with a special mold in fabrication and is mounted on the optical pickup unit 3, causing a cost increase by that.

Moreover, JP-A-7-262589 discloses an “optical pickup” having a dustproof cover to cover an aperture, and a flexible printed circuit board to mask an opening to adjust components disposed inside and a mounting hole for the dustproof cover, in order to surely facilitate a dustproof measure, to prevent dust such as dirt and waste from attaching to an electrical system or an optical system, and to avoid degradation of performance.

However, in the optical pickup unit mounted on such conventional disk drive, since the dustproof cover member is used as a separate member, assembly work thereof is required.

### SUMMARY OF THE INVENTION

Then, an object of the invention is to provide a disk drive, which prevents dust and dirt from entering an optical pickup unit with no use of a special dustproof cover member.

Thus, a disk drive according to according to the invention includes an optical pickup unit to irradiate light emitted from a light-emitting device onto a recording surface of a disk through a half-silvered mirror and an objective lens, guide the reflected light to a light-receiving device again through the objective lens and the half-silvered mirror, and convert it to an electrical signal, wherein the optical pickup unit has a frame slidably supported by guide shafts placed over a traverse chassis, the frame is formed with an internal space to accommodate an objective lens and an actuator for moving a position of the objective lens in a focus direction and a tracking direction and other components, a circuit board is mounted on an upper end of the frame, which masks the internal space, and an aperture is formed on the circuit board at a position corresponding to the objective lens. The circuit board functions as a relay circuit board to a control circuit board as well as functions as a dustproof cover.

Furthermore, preferably, a soldered short circuit part is disposed on the circuit board, which connects a control circuit board through a cable.

According to the disk drive of the invention thus configured, the circuit board can be functioned as a dustproof cover member to prevent dust and dirt from entering the inside. Furthermore, since it is unnecessary to fabricate a special dustproof cover member for assembly as before, and therefore the manufacturing cost can be reduced.

Moreover, since the soldered short circuit is positioned above the disk drive, soldered short circuit work for the optical pickup unit can be facilitated. Accordingly, the optical pickup unit can be quickly connected to the control circuit board in the disk drive, and time for assembly work and exchange work of the disk drive or the control circuit board can be shortened.

### BRIEF DESCRIPTION OF THE DRAWING

FIG. 1 is a plan view illustrating an optical pickup unit of a disk drive of an embodiment according to the invention;

FIG. 2 is a vertical cross-section of the optical pickup unit;

FIG. 3 is a plan view illustrating a conventional disk drive in which a tray thereof is opened;

FIG. 4 is a plan view illustrating a traditional optical pickup unit; and

FIG. 5 is a vertical cross-section of the optical pickup unit of FIG. 4.

### DETAILED DESCRIPTION OF PREFERRED EMBODIMENT

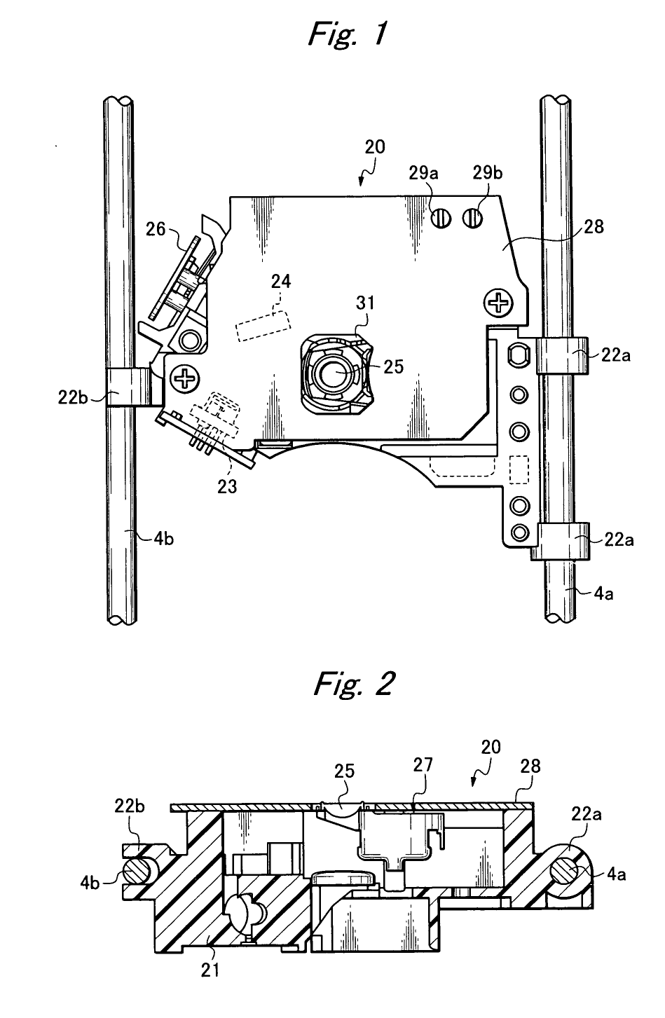

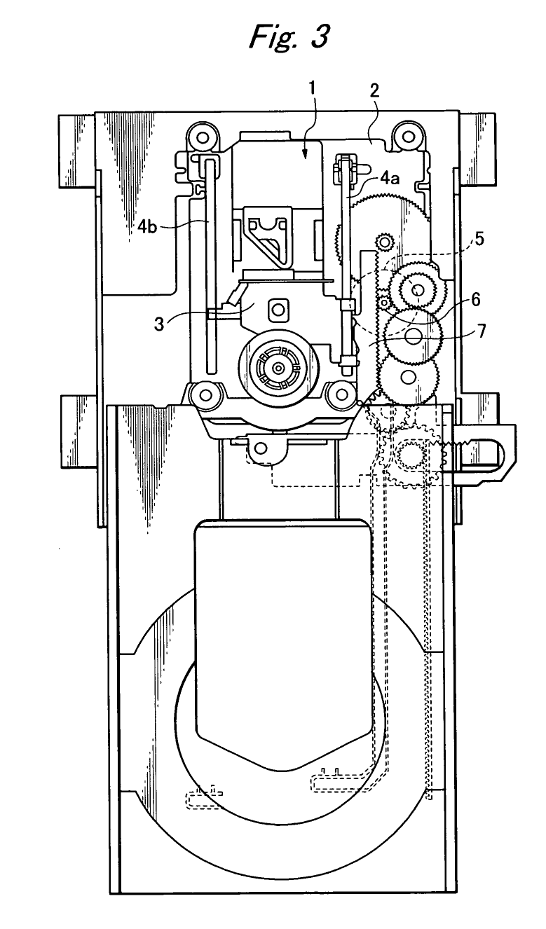

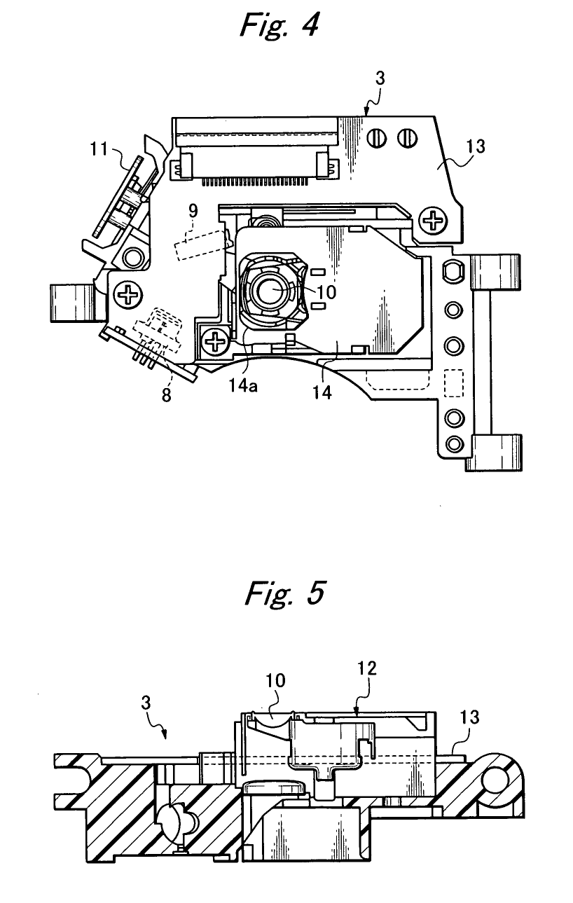

FIGS. 1 and 2 show an optical pickup unit 20 of a disk drive of an embodiment according to the invention. However, the structure other than that of the optical pickup unit is the same as the conventional one shown in FIG. 3, and the portions other than the optical pickup unit are referenced by numerals in FIG. 3.

The optical pickup unit 20 is configured as a part of a traverse unit 1, and is slidably mounted on two guide shafts 4a and 4b disposed on a traverse chassis 2. Two cylindrical bearings 22a and 22a are provided on one end of a frame 21 of the optical pickup unit 20, which are slidably fit on the guide shaft 4a. A U-shaped support part 22b is provided on the other end, which slidably cramps the guide shaft 4b. More specifically, the bearings 22a and 22a and the support part 22b are positioned and supported by the guide shafts 4a and 4b.

In the frame 21 of the optical pickup unit 20, a light-emitting device 23 formed of a laser diode is provided, which is configured to strike the light emitted from the light-emitting device 23 onto the recording surface of a disk, and to detect the reflected light to convert information recorded on the disk to electrical signals. Furthermore, a half-silvered mirror 24 is disposed in the frame 21. The light emitted from the light-emitting device 23 is reflected on the half-silvered mirror 24, passes through an objective lens 25 similarly disposed in the frame 21, and strikes the recording surface of the disk.

The light having struck the recording surface of the disk is reflected, again passes through the objective lens 25, penetrates through the half-silvered mirror 24, and enters a light-receiving device 26. The light is converted to electrical signals at the light-receiving device 26. Here, the light from the light-emitting device 23 is reflected on the half-silvered mirror 24 and sent to the objective lens 25, whereas the reflected light from the recording surface of the disk penetrates through the half-silvered mirror 24 from the objective lens 25, and is guided to the light-receiving device 26.

The light irradiated from the objective lens 25 needs to accurately trace the recording surface along with the rotation of the disk, and the objective lens 25 has the structure that it can moderately move in the focus direction (the vertical direction) and in the tracking direction (the radial direction of the disk). Therefore, the unit has an actuator 27, and the objective lens 25 accurately moves by the operation of the actuator 27 to permit the irradiated light to trace the recording surface.

Then, a relay circuit board 28 is screwed on the upper end of the frame 21, which converts information read out of the recording surface of the disk by the light-receiving device 26 to electrical signals and separately sends the converted electrical signals to a control circuit board of the disk drive through a cable. More specifically, the circuit board 28 serves as a relay to the control circuit board and also a relay of voltage supply required for drive of the actuator 27 and light emission of the light-emitting device 23, and is an essential component for the optical pickup unit 20. The circuit board 28 also serves as a dustproof cover member. However, an aperture 31 is formed at the position of the objective lens 25.

Two soldered short circuit parts 29a and 29b are disposed on the circuit board 28. Therefore, when soldered short circuit work is conducted in connecting another control circuit board to the circuit board 28, the soldered short circuit parts 29a and 29b can be used.

What is claimed is:

1. A disk drive comprising an optical pickup unit to irradiate light emitted from a light-emitting device onto a recording surface of a disk through a half-silvered mirror and an objective lens, guide the reflected light to a light-receiving device again through the objective lens and the half-silvered mirror, and convert it to an electrical signal,
wherein the optical pickup unit has a frame slidably supported by guide shafts placed over a traverse chassis,
the frame is formed with an internal space to accommodate an objective lens and an actuator for moving a position of the objective lens in a focus direction and a tracking direction and other components,
a circuit board is mounted on an upper end of the frame, which masks the internal space, and
an aperture is formed on the circuit board at a position corresponding to the objective lens.

2. The disk drive according to claim 1, wherein a soldered short circuit part is disposed on the circuit board for connecting a control circuit board.
